(19) United States
(12) Patent Application Publication
(10) Pub. No.: US 2019/0390786 A1
(43) Pub. Date: Dec. 26, 2019

(54) HYDRAULIC CIRCUIT

(71) Applicant: Honda Motor Co.,Ltd., Tokyo (JP)

(72) Inventors: Tomoaki MUKAI, Saitama (JP); Kota INOUE, Saitama (JP)

(73) Assignee: Honda Motor Co.,Ltd., Tokyo (JP)

(21) Appl. No.: 16/442,555

(22) Filed: Jun. 17, 2019

(30) Foreign Application Priority Data
Jun. 20, 2018 (JP) 2018-116931

(51) Int. Cl. F16K 17/04

(52) U.S. Cl. CPC F16K 17/0473; F04C 2/22

(57) ABSTRACT

The disclosure provides a hydraulic circuit without a dedicated to simplify the structure and reduce the cost. The hydraulic circuit includes an oil pump and a main control valve provided in an oil supply circuit which supplies oil discharged from the oil pump. When a line pressure that acts on the main control valve exceeds a first setting value, the main control valve opens to allow the oil to flow to the oil supply circuit. The main control valve is provided with a relief port connected to a suction side of the oil pump. When the line pressure that acts on the main control valve exceeds a second setting value larger than the first setting value, a part of the oil that flows through the oil supply circuit is returned to the suction side of the oil pump from the relief port of the main control valve.

### CROSS-REFERENCE TO RELATED APPLICATION

This application claims the priority benefit of Japan Application No. 2018-116931, filed on Jun. 20, 2018. The entirety of the above-mentioned patent application is hereby incorporated by reference herein and made a part of this specification.

### BACKGROUND

### Technical Field

The disclosure relates to a hydraulic circuit for supplying lubricating oil or the like.

### Description of Related Art

For example, a hydraulic circuit is known, which is for controlling an automatic transmission mounted on a vehicle by the oil pressure supplied from an oil pump (for example, see Patent Document 1). The automatic transmission disclosed in Patent Document 1 is a belt type continuously variable transmission, and the hydraulic circuit that controls the automatic transmission includes a circuit of an operating system which is composed of pulleys or the like, and a circuit of a lubricating system which supplies oil to various parts that constitute the continuously variable transmission to lubricate and cool them. Here, an example of the conventional hydraulic circuit is shown in FIG. 7 and FIG. 8.

That is, FIG. 7 is a diagram schematically showing the basic configuration of the conventional hydraulic circuit, and FIG. 8 is a diagram illustrating the operation of a relief valve of the hydraulic circuit. The hydraulic circuit 101 shown in FIG. 7 includes an operating circuit 103 for supplying operating oil to an operating part 102 such as a friction clutch, a lubricating circuit 105 for supplying lubricating oil to a first lubricating part 104a such as a friction clutch and a second lubricating part 104b such as a differential gear of a power transmission device, and an oil pump 106 driven by a part of the power of an engine, which is the drive source.

The lubricating circuit 105 is provided with a main control valve 107, a first lubricating pressure adjusting valve 108, a second lubricating pressure adjusting valve 109, and a relief valve 110. When the pressure (line pressure) of the oil, which is discharged from the rotating oil pump 106 and flows through the oil passages L11 and L12, exceeds a setting value, since one suction port 107a of the main control valve 107 communicates with two discharge ports 107b and 107c, the lubricating oil flows through the oil passages L13 and L14 of the lubricating circuit 105 and is respectively supplied to the lubricating parts 104a and 104b for lubricating and cooling the lubricating parts 104a and 104b.

When the pressure of the lubricating oil flowing through the lubricating circuit 105 becomes larger than the setting value, as shown in FIG. 8, the line pressure acting on the operating pressure port 110a of the relief valve 110 causes the spool 111 to slide in the direction of the arrow shown in the drawing (the right direction in FIG. 8), and the suction port 110b and the relief port 110c communicate with each other. Thus, the high pressure oil flowing through the oil passage L12 flows from the suction port 110b of the relief valve 110 to the oil passage L15 through the relief port 110c as indicated by the arrow in FIG. 8, and the high pressure oil is returned to the oil passage L17 on the suction side of the oil pump 106 from the oil passage L15 through the oil passage L16 shown in FIG. 7, so that it is possible to avoid abnormal pressure rise of the hydraulic circuit 101.

However, since the conventional hydraulic circuit 101 shown in FIG. 7 and FIG. 8 is provided with the dedicated relief valve 110 for preventing excessive pressure rise, the number of parts increases correspondingly. Therefore, there is room for further simplifying the structure and reducing the cost.

### Related Art

### Patent Document

[Patent Document 1] Japanese Laid-open No. 2015-200369

### SUMMARY

In view of the above, the disclosure provides a hydraulic circuit (1), including: an oil pump (6); and a main control valve (7) provided in an oil supply circuit (5), which supplies oil discharged from the oil pump (6). The main control valve (7) is configured to open when a line pressure (P) that acts on the main control valve (7) exceeds a first setting value (P1), to allow the oil to flow to the oil supply circuit (5). The main control valve (7) is provided with a relief port (9b) connected to a suction side of the oil pump (6), and when the line pressure (P) that acts on the main control valve (7) exceeds a second setting value (P2) larger than the first setting value (P1), a part of the oil that flows through the oil supply circuit (5) is returned to the suction side of the oil pump (6) from the relief port (9b) of the main control valve (7).

### BRIEF DESCRIPTION OF THE DRAWINGS

FIG. 1 is a diagram showing a configuration of the hydraulic circuit according to the disclosure.

FIG. 2 is a diagram showing the flow of oil in the hydraulic circuit according to the disclosure.

FIG. 3 is a diagram showing the flow of oil in the hydraulic circuit according to the disclosure.

FIG. 4 is a diagram illustrating an operation of the main control valve in the hydraulic circuit according to the disclosure.

FIG. 5 is a diagram illustrating an operation of the main control valve in the hydraulic circuit according to the disclosure.

FIG. 6 is a diagram illustrating an operation of the flow control valve in the hydraulic circuit according to the disclosure.

FIG. 7 is a diagram showing the basic configuration of the conventional hydraulic circuit.

FIG. 8 is a diagram showing an operation of the relief valve of the conventional hydraulic circuit.

### DESCRIPTION OF THE EMBODIMENTS

The disclosure provides a hydraulic circuit without a dedicated relief valve to achieve structure simplification and cost reduction.

In view of the above, the disclosure provides a hydraulic circuit (1), including: an oil pump (6); and a main control valve (7) provided in an oil supply circuit (5), which supplies oil discharged from the oil pump (6). The main control valve (7) is configured to open when a line pressure (P) that acts on the main control valve (7) exceeds a first setting value (P1), to allow the oil to flow to the oil supply circuit (5). The main control valve (7) is provided with a relief port (9b) connected to a suction side of the oil pump (6), and when the line pressure (P) that acts on the main control valve (7) exceeds a second setting value (P2) larger than the first setting value (P1), a part of the oil that flows through the oil supply circuit (5) is returned to the suction side of the oil pump (6) from the relief port (9b) of the main control valve (7).

According to the disclosure, since the main control valve has the function of a relief valve, a dedicated relief valve which is necessary for the related art is not required, and it is possible to simplify the structure of the hydraulic circuit and reduce the cost correspondingly. In addition, by providing the relief port in the main control valve, the pressure regulating performance of the hydraulic circuit can be improved, and it is possible to suppress excessive rise of the oil pressure and improve hydraulic vibration.

Then, in the disclosure, the main control valve (7) may be a spool valve, and when a line pressure (P) that acts on an operating pressure port (9a) of the main control valve (7) exceeds the second setting value (P2), a spool (10) may slide to communicate a suction port (9c) and the relief port (9b).

Also, in the disclosure, a flow control valve (8) may be provided in the oil supply circuit (5) on a downstream side of the main control valve (7), and the flow control valve (8) may be configured so that when a line pressure (P) that acts on the flow control valve (8) exceeds a third setting value (P3), a part of the oil that flows through the oil supply circuit (5) is returned to the suction side of the oil pump (6).

Additionally, in the disclosure, the flow control valve (8) may be a spool valve and include a suction port (12b) connected to the oil supply circuit (5), and a return port (12c) connected to the suction side of the oil pump (6). When the line pressure (P) that acts on the flow control valve (8) is under the third setting value (P3), the suction port (12b) may be closed by a spool (13), and when the line pressure (P) exceeds the third setting value (P3), the suction port (12b) and the return port (12c) may communicate with each other by a spool groove (13a) formed on the spool (13).

Furthermore, an orifice (17) may be provided in an oil passage (L7) that branches from the oil supply circuit (5) and is connected to the suction port (12b) of the flow control valve (8).

According to the disclosure, it is possible to omit a dedicated relief valve to simplify the structure of the hydraulic circuit and reduce the cost.

Embodiments of the disclosure will be described below with reference to the accompanying drawings.

### [Basic Configuration of Hydraulic Circuit]

First, a basic configuration of a hydraulic circuit according to the disclosure will be described.

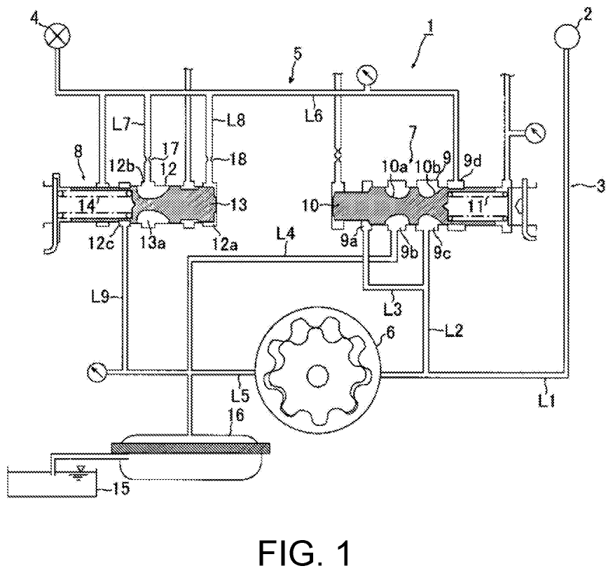

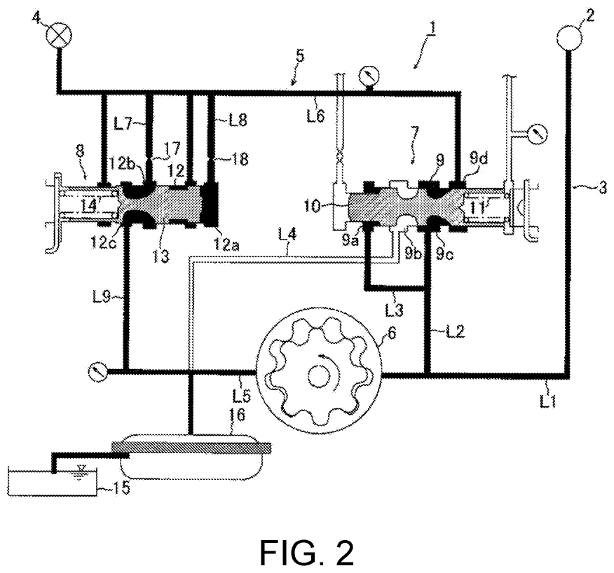

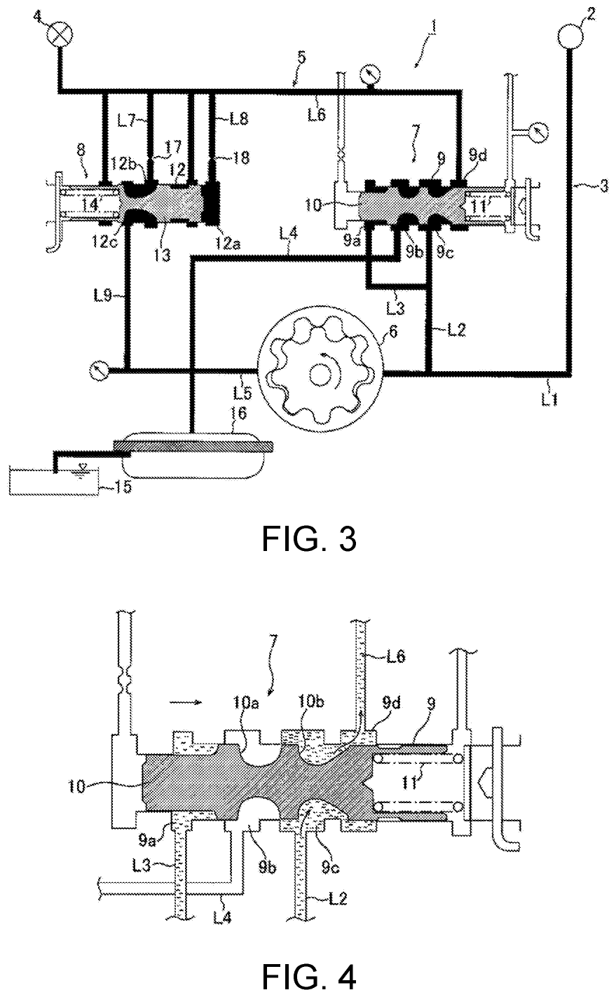

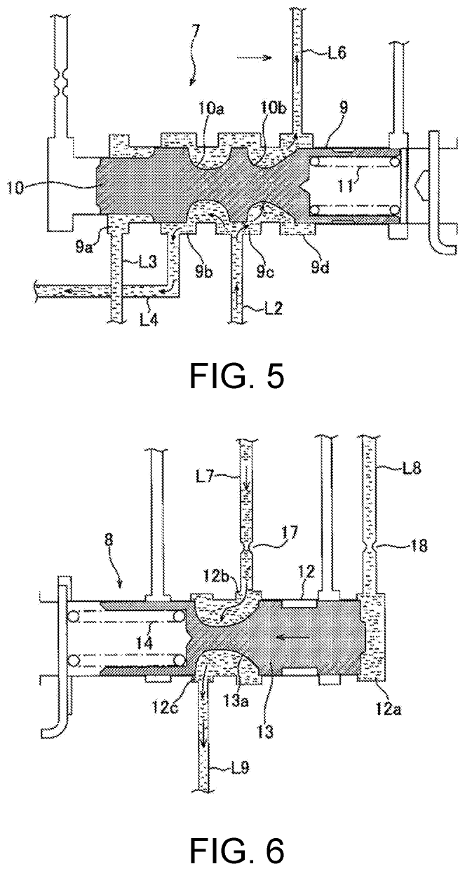

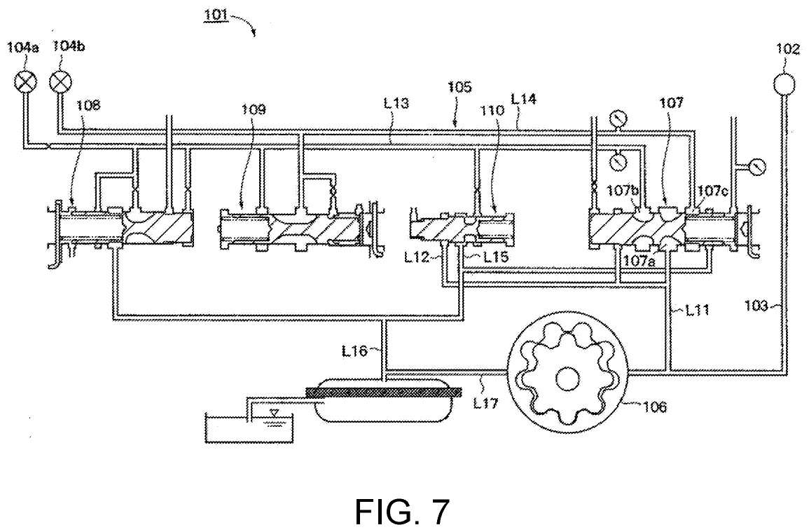

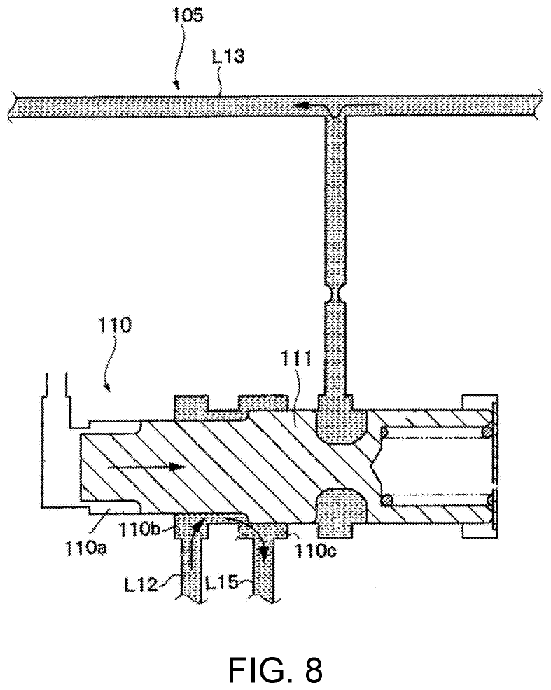

FIG. 1 is a diagram showing the configuration of the hydraulic circuit according to the disclosure. FIG. 2 and FIG. 3 are diagrams showing the flow of oil in the hydraulic circuit according to the disclosure. FIG. 4 and FIG. 5 are diagrams illustrating an operation of a main control valve in the hydraulic circuit. FIG. 6 is a diagram illustrating an operation of a flow control valve in the hydraulic circuit.

The hydraulic circuit 1 according to the present embodiment is for supplying operating oil and lubricating oil to a power transmission device mounted on a vehicle. The hydraulic circuit 1 includes an operating circuit 3 that supplies operating oil for drive control to an operating part 2 such as a friction clutch, a lubricating circuit (hereinafter referred to as “oil supply circuit”) 5 that supplies lubricating oil to a lubricating part 4 of parts such as a friction clutch and a differential gear, an oil pump 6 that is rotationally driven by a part of the power of an engine or the like which is the drive source, a main control valve 7 provided in the lubricating circuit 5, and a flow control valve 8 provided downstream of the main control valve 7 of the lubricating circuit 5.

The main control valve 7 is a spool valve. The main control valve 7 has a configuration that, as shown in detail in FIG. 4, a spool 10 is fitted into a cylinder 9 to be slidable in the lateral direction of FIG. 4, and a spring 11 for urging the spool 10 to the left in FIG. 4 is housed in the cylinder 9. Then, two spool grooves 10a and 10b are formed on the outer periphery of the spool 10. In addition, the cylinder 9 of the main control valve 7 is formed with an operating pressure port 9a, a relief port 9b, a suction port 9c, and a discharge port 9d, on which a line pressure (operating pressure) for sliding the spool 10 acts.

The flow control valve 8 is also a spool valve similar to the main control valve 7. The flow control valve 8 has a configuration that, as shown in detail in FIG. 6, a spool 13 is fitted into a cylinder 12 to be slidable in the lateral direction of FIG. 6, and a spring 14 for urging the spool 13 to the right in FIG. 6 is housed in the cylinder 12. Then, one spool groove 13a is formed on the outer periphery of the spool 13 of the flow control valve 8. Further, the cylinder 12 of the flow control valve 8 is formed with an operating pressure port 12a, a suction port 12b, and a return port 12c, on which a line pressure (operating pressure) for sliding the spool 13 acts.

As shown in FIG. 1, an oil passage L1 extending from the discharge side of the oil pump 6 constitutes a part of the operating circuit 3 and is connected to the operating part 2, and an oil passage L2 branching from the oil passage L1 is connected to the suction port 9c of the main control valve 7. Then, an oil passage L3 branching from the oil passage L2 is connected to the operating pressure port 9a of the main control valve 7. Further, an oil passage L4 extending from the relief port 9b of the main control valve 7 is connected to an oil passage L5 connected to the suction side of the oil pump 6. When the oil pump 6 is driven, the oil stored in an oil pan 15 is purified through a strainer 16, and then is sucked from the oil passage L5 to the oil pump 6 and pressurized to a predetermined pressure.

In addition, an oil passage L6 extending from the discharge port 9d of the main control valve 7 constitutes a part of the oil supply circuit 5 and is connected to the lubricating part 4, and an oil passage L7 branching from the oil passage L6 is connected to the suction port 12b of the flow control valve 8. Then, an orifice 17 for controlling the flow rate of the oil flowing therethrough is provided in the middle of the oil passage L7. In addition, an oil passage L8 branches from the oil passage L6, and the oil passage L8 is connected to the operating pressure port 12a of the flow control valve 8. The oil passage L8 is also provided with an orifice 18.

Moreover, one end of an oil passage L9 is connected to the return port 12c of the flow control valve 8, and the other end of the oil passage L9 is connected to the oil passage L5 connected to the suction side of the oil pump 6.

### [Operation of Hydraulic Circuit]

Next, an operation of the hydraulic circuit 1 configured as described above will be described.

In the state where the oil pump 6 is stopped, as shown in FIG. 1, oil does not flow through the hydraulic circuit 1, but when the oil pump 6 is rotationally driven by a part of the power of the drive source such as an engine, a part of the oil pressurized by the oil pump 6 is supplied to the operating part 2 via the oil passage L1, as shown in FIG. 2, for drive control of the operating part 2. Further, as shown in FIG. 2 and FIG. 4, another part of the oil causes an operating pressure (line pressure) to act on the operating pressure port 9a of the main control valve 7 via the oil passages L2 and L3.

When the oil pump 6 is rotationally driven at a relatively low load, the pressure of the oil discharged from the oil pump 6 is relatively low. At this time, if the line pressure P acting on the operating pressure port 9a of the main control valve 7 via the oil passages L2 and L3 exceeds a first setting value P1 (P>P1), as shown in FIG. 4, the spool 10 of the main control valve 7 slides to the right in FIG. 5 (the direction of the arrow shown in the drawing) against the urging force of the spring 11, and the suction port 9c and the discharge port 9d communicate with each other via the spool groove 10b formed therein. Then, as shown in FIG. 2 and FIG. 4, the oil that flows from the oil pump 6 to the suction port 9c of the main control valve 7 via the oil passage L2 flows from the discharge port 9d to the oil passage L6 and heads to the lubricating part 4.

Then, when the line pressure P acting on the operating pressure port 9a of the main control valve 7 exceeds P2 (second setting value) which is larger than P1 (P>P2>P1), the spool 10 of the main control valve 7 slides further to the right against the urging force of the spring 11, as shown in FIG. 5, and communicates the suction port 9c with the relief port 9b and the discharge port 9d. Thereby, as shown in FIG. 3, the oil discharged from the oil pump 6 and supplied from the oil passage L2 to the main control valve 7 flows from the suction port 9c into the relief port 9b and the discharge port 9d, and the oil that flows into the suction port 9c is drawn from the relief port 9b to the oil passage L5 on the suction side of the oil pump 6 via the oil passage L4. Therefore, the main control valve 7 functions as a relief valve, and since the pressure of the hydraulic circuit 1 is withdrawn by the main control valve 7, the pressure regulating function of the hydraulic circuit 1 can be improved. The oil pressure P2 (second setting value) here is the pressure regulating point of the line pressure.

In the flow control valve 8, the pressure of the oil that flows through the oil passage L6 acts on the operating pressure port 12a via the oil passage L8 and the orifice 18 as the line pressure P, but when the line pressure P is under P3 (third setting value) (P≤P3), the spool 13 of the flow control valve 8 blocks the oil passage L7, and therefore the return of the oil from the oil passage L9 to the oil passage L5 on the suction side of the oil pump 6 is blocked. Thus, all the oil that flows through the oil passage L6 of the oil supply circuit 5 is supplied to the lubricating part 4, and the lubricating part 4 is lubricated and cooled by a necessary and sufficient amount of oil. The oil pressure P3 here is an oil pressure set separately from the oil pressure P1 and the oil pressure P2, and the relationship between P1, P2, and P3 may be changed as desired by setting the main control valve 7 and the flow control valve 8.

Furthermore, when the line pressure P that acts on the operating pressure port 12a of the flow control valve 8 from the oil passage L8 exceeds the third setting value P3 (P>P3), as shown in FIG. 6, the spool 13 slides to the left (the direction of the arrow shown in the drawing) against the urging force of the spring 14. Then, the spool groove 13a formed on the spool 13 communicates the suction port 12b and the return port 12c. Thereby, a part of the oil that flows through the oil passage L6 of the oil supply circuit 5 toward the lubricating part 4 flows from the oil passage L6 into the suction port 12b of the flow control valve 8 through the oil passage L7 and the orifice 17, and flows from the suction port 12b to the return port 12c through the spool groove 13a and is returned to the oil passage L5 on the suction side of the oil pump 6 through the oil passage L9 connected to the return port 12c, as shown in FIG. 2 and FIG. 6. The remaining oil flows directly toward the lubricating part 4, as shown in FIG. 2, for lubricating and cooling the lubricating part 4.

As described above, when the line pressure P that acts on the operating pressure port 12a of the flow control valve 8 exceeds the third setting value P3 (P>P3), a part of the oil that flows through the oil passage L6 of the oil supply circuit 5 bypasses the lubricating part 4 and is returned from the oil passage L7 to the oil passage L5 on the suction side of the oil pump 6 through the flow control valve 8 and the oil passage L9. Thus, the flow rate of the oil supplied to the lubricating part 4 is suppressed to be small. Therefore, the frictional resistance of the oil in the lubricating part 4 is suppressed to be low, which improves the fuel efficiency of the vehicle. In addition, since the extra oil that flows through the oil passage L6 of the oil supply circuit 5 is returned from the return port 12c of the flow control valve 8 to the oil passage L5 on the suction side of the oil pump 6 via the oil passage L9, the pump efficiency of the oil pump 6 is increased and the fuel efficiency of the vehicle is further improved. Further, in the present embodiment, since the oil passage L7 that branches from the oil passage L6 and is connected to the suction port 12b of the flow control valve 8 is provided with the orifice 17, the amount of oil flowing through the oil passage L7 is limited by the orifice 17 and the flow rate of the oil supplied from the oil passage L6 to the lubricating part 4 is larger than the flow rate of the oil returned from the oil passage L9 to the oil passage L5 on the suction side of the oil pump 6, and a necessary and sufficient amount of oil can be supplied to the lubricating part 4.

As described above, in the hydraulic circuit 1 of the disclosure, the main control valve 7 has the function of a relief valve. Therefore, a dedicated relief valve which is necessary for the related art is not required, and correspondingly the disclosure can simplify the structure of the hydraulic circuit 1 and reduce the cost.

Nevertheless, the disclosure is not limited to the embodiments described above, and various modifications may be made within the scope of the technical concept described in the claims, specification, and drawings.

What is claimed is:

1. A hydraulic circuit, comprising:
an oil pump; and
a main control valve provided in an oil supply circuit, which supplies oil discharged from the oil pump,
wherein the main control valve is configured to open when a line pressure that acts on the main control valve exceeds a first setting value, to allow the oil to flow to the oil supply circuit, and
the main control valve is provided with a relief port connected to a suction side of the oil pump, and when the line pressure that acts on the main control valve exceeds a second setting value larger than the first setting value, a part of the oil that flows through the oil supply circuit is returned to the suction side of the oil pump from the relief port of the main control valve.

2. The hydraulic circuit according to claim 1, wherein the main control valve is a spool valve, and when a line pressure that acts on an operating pressure port of the main control valve exceeds the second setting value, a spool slides to communicate a suction port and the relief port.

3. The hydraulic circuit according to claim 1, wherein a flow control valve is provided in the oil supply circuit on a downstream side of the main control valve, and the flow control valve is configured so that when a line pressure that acts on the flow control valve exceeds a third setting value, a part of the oil that flows through the oil supply circuit is returned to the suction side of the oil pump.

4. The hydraulic circuit according to claim 3, wherein the flow control valve is a spool valve and comprises a suction port connected to the oil supply circuit, and a return port connected to the suction side of the oil pump,
when the line pressure that acts on the flow control valve is under the third setting value, the suction port is closed by a spool, and
when the line pressure exceeds the third setting value, the suction port and the return port communicate with each other by a spool groove formed on the spool.

5. The hydraulic circuit according to claim 4, wherein an orifice is provided in an oil passage that branches from the oil supply circuit and is connected to the suction port of the flow control valve.

6. The hydraulic circuit according to claim 2, wherein a flow control valve is provided in the oil supply circuit on a downstream side of the main control valve, and the flow control valve is configured so that when a line pressure that acts on the flow control valve exceeds a third setting value, a part of the oil that flows through the oil supply circuit is returned to the suction side of the oil pump.

7. The hydraulic circuit according to claim 6, wherein the flow control valve is a spool valve and comprises a suction port connected to the oil supply circuit, and a return port connected to the suction side of the oil pump,
when the line pressure that acts on the flow control valve is under the third setting value, the suction port is closed by a spool, and
when the line pressure exceeds the third setting value, the suction port and the return port communicate with each other by a spool groove formed on the spool.

8. The hydraulic circuit according to claim 7, wherein an orifice is provided in an oil passage that branches from the oil supply circuit and is connected to the suction port of the flow control valve.
